(19) United States
(12) Patent Application Publication
(10) Pub. No.: US 2026/0192564 A1
(43) Pub. Date: Jul. 9, 2026

(54) INKJET PRINTING HEAD, INKJET PRINTING DEVICE INCLUDING THE SAME, AND METHOD FOR MANUFACTURING THE INKJET PRINTING HEAD

(71) Applicant: Samsung Display Co., LTD., Yongin-si (KR)

(72) Inventors: SEUNGHO YOON, Yongin-si (KR); JAESIK KIM, Yongin-si (KR); JUNGHAN SEO, Yongin-si (KR); WOO YONG SUNG, Yongin-si (KR); BYEONGJUN LEE, Yongin-si (KR)

(21) Appl. No.: 19/273,838

(22) Filed: Jul. 18, 2025

(30) Foreign Application Priority Data
Jan. 6, 2025 (KR) 10-2025-0001668

(51) Int. Cl. B41J 2/14; B41J 2/16; B41J 29/17

(52) U.S. Cl. CPC B41J 2/1433; B41J 2/1606; B41J 2/162; B41J 2/1626; B41J 2/164; B41J 29/17

(57) ABSTRACT

An inkjet printing head includes a head unit and a nozzle unit. The nozzle unit includes a base layer, a supplementary part, a metal oxide layer, and a first metallic film. The base layer has an opening area defined therein and includes a first portion adjacent to the opening area and a second portion extending from the first portion. The supplementary part is disposed below the base layer and overlaps with the first portion. The metal oxide layer is disposed below the base layer and overlaps with the second portion. At least a portion of the first metallic film is disposed below the supplementary part and the metal oxide layer. A first distance between a lower surface of the first portion and the first metallic film is different from a second distance between a lower surface of the second portion and the first metallic film.

This application claims priority to Korean Patent Application No. 10-2025-0001668, filed on Jan. 6, 2025, and all the benefits accruing therefrom under 35 U.S.C. § 119, the content of which in its entirety is herein incorporated by reference.

### BACKGROUND

### 1. Field

The disclosure relates to an inkjet printing head, an inkjet printing device including the same, and a manufacturing method for an inkjet printing head. Particularly, the disclosure relates to an inkjet printing head having a portion of ink's ejection planarized by injecting a monomer to a worn nozzle surface, an inkjet printing device including the same, and a manufacturing method for an inkjet printing head.

### 2. Description of the Related Art

An inkjet printing device ejects ink through a nozzle from an inkjet printing head to manufacture a pixel of a display device. Upon ejecting ink, ink may be stained on a surface of the nozzle, and undischarged ink may block the nozzle. The ink stained on a surface of the nozzle may reduce ejection performance of the nozzle. Therefore, a process of physically or chemically cleaning the nozzle surface is performed. Normally, a blotting process of wiping the nozzle surface with cloth is performed.

### SUMMARY

When the blotting process repeats, the nozzle surface becomes worn out due to friction, and a coated layer on the nozzle surface may be peeled off. Due to the worn nozzle surface, liquid ejection property is reduced, and it becomes difficult to eject ink on a desired position. As a result, life cycles of the inkjet printing head and the inkjet printing device including the same end, and the inkjet printing head and the inkjet printing device including the same should be discarded.

A feature of the disclosure is to provide an inkjet printing head having a portion of ink's ejection planarized by injecting a monomer to a worn nozzle surface, an inkjet printing device including the same, and a manufacturing method for an inkjet printing head.

Another feature of the disclosure is to planarize a worn nozzle surface nozzle surface and re-use an inkjet printing head, whose life cycle has ended, and an inkjet printing head including the same.

An inkjet printing head in an embodiment of the disclosure may include a head unit and a nozzle unit. The nozzle unit may be disposed adjacent to the head unit. The nozzle unit may include a base layer, a supplementary part, a metal oxide layer, and a first metallic film. The base layer may have an opening area therein. The base layer may include a first portion adjacent to the opening area and a second portion extending from the first portion. The supplementary part may be disposed below the base layer and overlap with the first portion. The metal oxide layer may be disposed below the base layer and overlap with the second portion. The first metallic film may have at least a portion disposed below the supplementary part and the metal oxide layer.

In an embodiment, a first distance between a lower surface of the first portion and the first metallic film may be different from a second distance between a lower surface of the second portion and the first metallic film.

In an embodiment, the first distance may be greater than the second distance.

In an embodiment, a first thickness of the supplementary part may be different from a second thickness of the metal oxide layer.

In an embodiment, the first thickness may be greater than the second thickness.

In an embodiment, the supplementary part may have a first surface roughness, and the metal oxide layer may have a second surface roughness smaller than the first surface roughness.

In an embodiment, another portion of the first metallic film may be disposed in the opening area.

In an embodiment, an inkjet printing head may further include a second metallic film disposed below the first metallic film.

In an embodiment, an inkjet printing head may further include a monomolecular film disposed below the second metallic film.

In an embodiment, an inkjet printing head of the disclosure may further include a planarization film disposed between the metal oxide layer and the first metallic film.

In an embodiment, the metal oxide layer may include silicon oxide.

An inkjet printing device in an embodiment of the disclosure may include a stage, a head unit, and a nozzle unit. The nozzle unit may include a base layer, a supplementary part, a metal oxide layer, and a first metallic film. A substrate may be disposed (e.g., mounted) on the stage. The head unit may be disposed on the stage and supply ink. The nozzle unit may be disposed adjacent to the head unit. A first passageway which ejects the ink onto the substrate and a second passageway connected to the first passageway may be defined in the nozzle unit. The base layer may include a first portion adjacent to the second passageway and a second portion extending from the first portion. The supplementary part may be disposed below the base layer and overlap with the first portion. The metal oxide layer may be disposed below the base layer and overlap with the second portion. The first metallic film may be disposed below the supplementary part and the metal oxide layer.

In an embodiment, the first passageway has a smaller width towards the second passageway. At least a portion of the supplementary part may overlap with the first passageway in a plan view.

In an embodiment of the disclosure, a spacing between a lower surface of the first portion and the first metallic film may be a first distance. A spacing between a lower surface of the second portion and the first metallic film may be a second distance. The first distance may be greater than the second distance.

In an embodiment, the supplementary part may have a first thickness. The metal oxide layer may have a second thickness different from the first thickness. The first thickness may be greater than the second thickness.

In an embodiment, the supplementary part may have a first surface roughness. The metal oxide layer may have a second surface roughness smaller than the first surface roughness.

A manufacturing method for an inkjet printing head in an embodiment of the disclosure may include preparing, forming a shield unit, etching the shield unit, forming a passageway, forming a first metallic film, forming a second metallic film, and forming a monomolecular film. The operation of preparing may include preparing a damaged inkjet printing head including a head unit and a nozzle unit disposed adjacent to the head unit. The nozzle unit may include a base layer having an opening area defined therein and a metal oxide layer disposed below a portion of the base layer. In the operation of forming a shield unit, the opening area and another portion of the base layer may be applied with a material including a monomer, and the applied material may be pre-cured. In the operation of etching the shield unit, some of the applied material may be etched. In the operation of forming a passageway, a cleaning solution may be introduced through the opening area to remove a portion of the shield unit disposed in the opening area. In the operation of forming a first metallic film, the first metallic film disposed below the metal oxide layer may be formed. In the operation of forming a second metallic film, the second metallic film disposed below the first metallic film may be formed. In the operation of forming a monomolecular film, the monomolecular film disposed below the second metallic film may be formed.

In an embodiment, a manufacturing method for an inkjet printing head may further include forming a planarization film below the metal oxide layer between the operation of etching the shield unit and the operation of forming the passageway.

In an embodiment of the disclosure, the cleaning solution may include a material of an acetone type.

In an embodiment of the disclosure, the operation of forming the first metallic film and the operation of forming the second metallic film may each be performed by any one of an atomic layer deposition (“ALD”) method, a physical vapor deposition (“PVD”) method, and a sputter deposition method.

By embodiments of the disclosure, it becomes possible to provide an inkjet printing head having a portion of ink's ejection planarized by injecting a monomer to a worn nozzle surface, an inkjet printing device including the same, and a manufacturing method for an inkjet printing head.

By embodiments of the disclosure, it becomes possible to increase a lifespan of an inkjet printing head and an inkjet printing device including the same by re-using an inkjet printing head, whose life cycle has ended, and an inkjet printing device including the same.

### BRIEF DESCRIPTION OF THE DRAWINGS

These and/or other features will become apparent and more readily appreciated from the following description of the embodiments, taken in conjunction with the accompanying drawings in which:

FIG. 1 is a perspective view of an embodiment of an inkjet printing device according to the disclosure;

FIG. 2 is a plan view of an embodiment of an inkjet printing device according to the disclosure;

FIG. 3 is a magnified view of an embodiment of a nozzle unit of an inkjet printing device according to the disclosure;

FIG. 4 is a flow chart of an embodiment of a manufacturing method for an inkjet printing head according to the disclosure;

FIG. 5A through FIG. 5H are illustrations of an embodiment of a manufacturing method for an inkjet printing head according to the disclosure;

FIG. 6 is an magnified illustration of an embodiment of a nozzle unit of an inkjet printing device according to the disclosure;

FIG. 7A and FIG. 7B are magnified illustrations of an embodiment of a nozzle unit of an inkjet printing device according to the disclosure;

FIG. 8A and FIG. 8B are magnified illustrations of an embodiment of a nozzle unit of an inkjet printing device according to the disclosure; and

FIG. 9A through FIG. 9C are magnified illustrations of an embodiment of a nozzle unit of an inkjet printing device according to the disclosure.

### DETAILED DESCRIPTION

References will now be made in detail to illustrative embodiments, of which examples are illustrated in the accompanying drawings, where like reference numerals refer to like elements throughout. The embodiments may have a variety of forms and permutations, but the disclosure shall by no means be construed as being limited to the described embodiments. Rather, the disclosure shall be construed to encompass all forms, permutations, equivalents and substitutes covered by the technical ideas and scope of the disclosure. Accordingly, the embodiments are merely described below, by referring to the drawing figures, to explain features of the disclosure.

In the accompanying drawings, the thicknesses, ratios, and dimensions of the elements may not be to exact scale and may have been exaggerated for the benefit of effective explanation of the technical features associated with these elements.

An expression such as “comprising” or “including” is intended to designate a characteristic, a number, a step, an operation, an element, a part or combinations thereof, and shall not be construed to preclude any possibility of presence or addition of one or more other characteristics, numbers, steps, operations, elements, parts or combinations thereof.

Terms such as “first” and “second” may be used in describing various elements, but the above elements shall not be restricted to the above terms. The above terms may be used only to distinguish one element from the other. For instance, the first element may be named the second element, and vice versa, without departing the scope of claims of the disclosure. Unless clearly used otherwise, any expressions in a singular form may include a meaning of a plural form. The term “and/or” shall include the combination of a plurality of listed items or any of the plurality of listed items.

Unless otherwise defined, all terms, including technical terms and scientific terms, used herein have the same meaning as how they are generally understood by those of ordinary skill in the art to which the disclosure pertains. Any term that is defined in a general dictionary shall be construed to have the same meaning in the context of the relevant art, and, unless otherwise defined explicitly, shall not be interpreted to have an idealistic or excessively formalistic meaning.

In the specification, when an element, such as a layer, a film, a region, and a plate, is “on” or “above” another element, this includes not only a case of being “directly on” the other element, but also a case of having yet another element therebetween. In the contrary, when an element, such as a layer, a film, a region, and a plate, is “below” or “under” another element, this includes not only a case of being “directly under” the other element, but also a case of having yet another element therebetween. Furthermore, in the specification, when an element is disposed “on” another element, this includes not only disposition above the other element but also disposition below the other element. Terms, such as a “film” and “thin film,” are used herein for convenience. Terms, such as a “film” and “thin film,” are used to refer to any continuous or non-continuous structures or materials deposited through methods disclosed herein. For example, a “film” or a “thin film” may include a partial or complete molecular layers, or a partial or complete atomic layers with units of 2D materials, nanorods, nanotubes, or nanoparticles, or clusters of atoms and/or molecules. A “film” or “thin film” may include a material or layer provided with pinholes, but still remain at least partially continuous.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” may mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

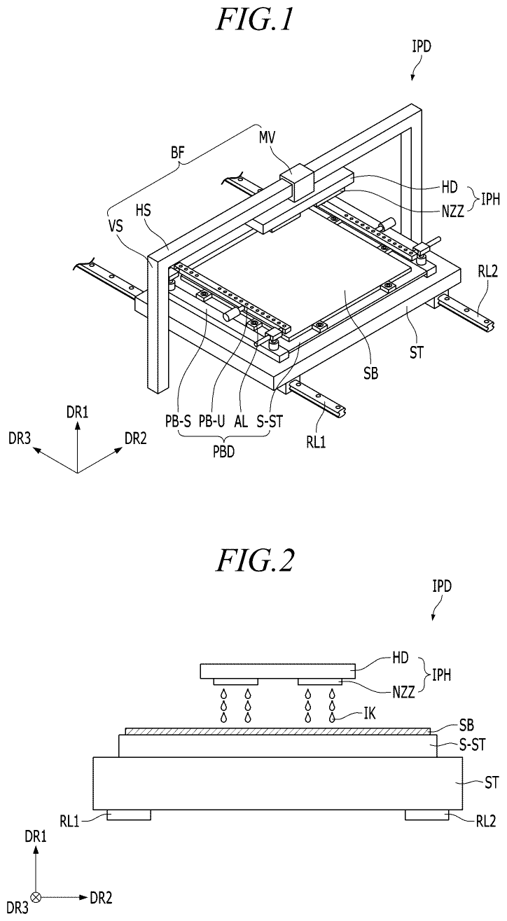

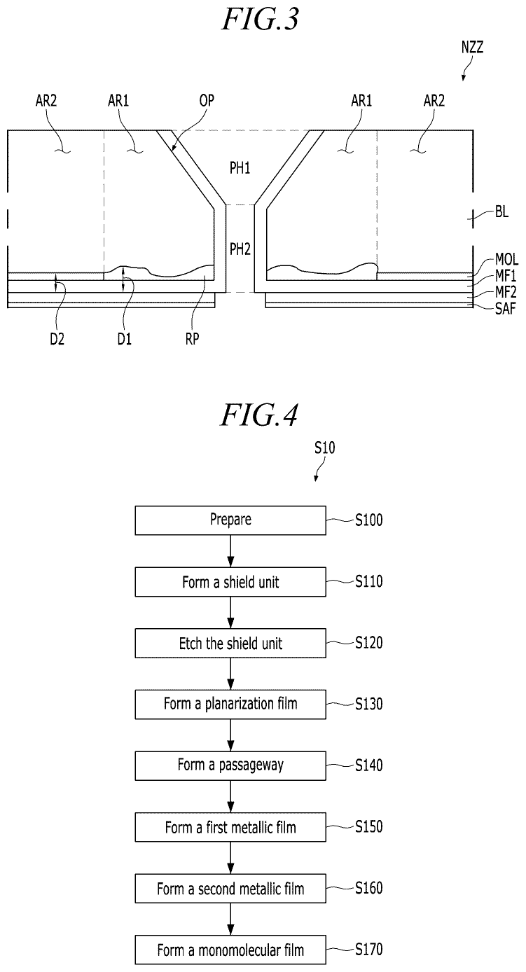

FIG. 1 is a perspective view of an embodiment of an inkjet printing device IPD according to the disclosure. FIG. 2 is a plan view of an embodiment of an inkjet printing device IPD according to the disclosure.

In this specification, a first direction DR1, a second direction DR2, and a third direction DR3 are defined. The second direction DR2 and the third direction DR3 may be perpendicular to each other in one plane. The first direction DR1 may be perpendicular to a plane formed by the second direction DR2 and the third direction DR3. Hereinafter, in the descriptions about an inkjet printing device IPD in this specification, unless it is separately indicated, the term “above part” may refer to one side of the first direction DR1, and the term “upper surface” may refer to a surface facing one side of the first direction DR1. In addition, the term “below part” may refer to another side of the first direction DR1, and the term “lower surface” may refer to a surface facing an opposite side of the first direction DR1. Furthermore, the terms, “left,” “right,” “above,” and “below,” refer to directions upon viewing an inkjet printing device IPD in a plan view. In an embodiment, the term “right” refers to one side of the second direction DR2, the term “left” refers to another side of the second direction DR2, the term “above” refers to one side of the third direction DR3, and the term “below” refers to another side of the third direction DR3, for example.

An inkjet printing device IPD in an embodiment of the disclosure may include rails RL1 and RL2, a stage ST, a probe device PBD, a base frame BF, and an inkjet printing head IPH.

The rails RL1 and RL2 may include a first rail RL1 and a second rail RL2. The first rail RL1 may be disposed below a left portion of the inkjet printing device IPD. The second rail RL2 may be disposed below a right portion of the inkjet printing device IPD.

The rails RL1 and RL2 may be disposed below the stage ST and reciprocate the stage in the third direction DR3.

The stage ST may provide a region for disposition of a substrate SB. The stage ST may have a quadrangular shape, e.g., rectangular shape. However, the disclosure is not limited thereto. In an embodiment, the stage ST may have a different shape corresponding to a shape of the substrate SB, for example.

The substrate SB may be disposed on the stage ST.

The substrate SB may be an inorganic light-emitting display device, an organic light-emitting display device, a micro light-emitting display device, or a quantum dot light-emitting display device. However, the disclosure is not limited thereto.

The probe device PBD may include a sub stage S-ST, a probe support PB-S, a probe unit PB-U, and an aligner AL.

The probe device PBD may align a particle of ink IK sprayed on the substrate SB. Particularly, an electric field on the substrate SB may be formed by the probe device PBD. The electric field may be transferred to the ink IK sprayed on the substrate SB. A particle included in the ink IK may be aligned on the substrate SB.

The sub stage S-ST may provide a space for disposition of a substrate SB. A planar shape of the sub stage S-ST may be modified to another shape corresponding to a planar shape of the substrate SB. In this specification, the substrate SB is illustrated to have a quadrangular shape, e.g., rectangular shape, and a shape of the sub stage S-ST is also illustrated as a rectangle. However, the disclosure is not limited thereto.

An aligner AL, a probe support PB-S, and a probe unit PB-U may be disposed on the sub stage S-ST.

The aligner AL may be disposed on each side of the sub stage S-ST.

A probe support PB-S may provide a space for disposition of the probe unit PB-U.

The probe unit PB-U may be disposed on the probe support PB-S and have an electric field formed on the substrate SB disposed on the sub stage S-ST.

The base frame BF may include supports HS and VS, and a transfer unit MV.

The supports HS and VS may include a horizontal support HS and a vertical support VS.

The horizontal support HS may extend in the second direction DR2 and have a stick shape.

The vertical support VS may extend in the first direction DR1 and be spaced part from a ground surface to have a selectable height. The vertical support VS may be connected to opposite ends of the horizontal support HS in the second direction DR2 and support the horizontal support HS. The vertical support VS and the horizontal support HS may be a solid frame and a structure which stably sprays ink from above.

The transfer unit MV may be connected to the horizontal support HS. Particularly, the transfer unit MV may have a shape surrounding a frame of the horizontal support HS. The transfer unit MV may move along the second direction DR2 on the horizontal support HS.

As described above, the stage ST may move along the third direction DR3, and the transfer unit MV may reciprocate along the second direction DR2. Therefore, the inkjet printing device IPD may evenly perform a printing process on an entirety of the area of the substrate SB disposed on the stage ST.

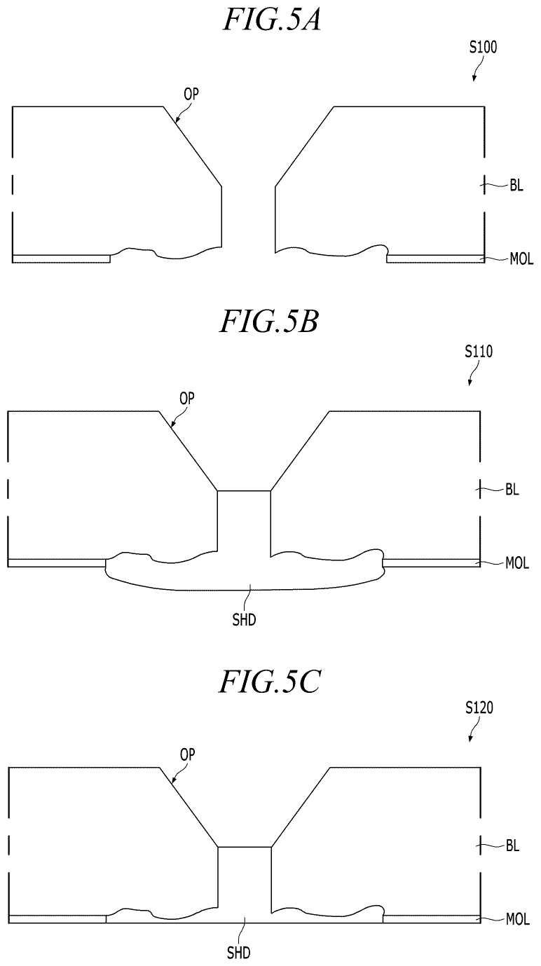

The inkjet printing head IPH may include a head unit HD and a nozzle unit NZZ. Hereinafter, FIG. 1 and FIG. 2 show only a disposition relationship between the head unit HD and the nozzle unit NZZ, and detailed description about the nozzle unit NZZ will be made with reference to FIG. 3.

The head unit HD may be spaced apart from the stage ST in the first direction DR1. A distance between the head unit HD and the stage ST may be controlled by a height of the vertical support VS. The head unit HD may be directly disposed on the transfer unit MV through a separate coupling member. In another embodiment, the head unit HD may be coupled on the transfer unit MV through a separate coupling member. However, the disclosure is not limited thereto. A coupling means of the head unit HD to the base frame BF may be limitlessly modified. As the transfer unit MV reciprocates in the second direction DR2, the head unit HD may also reciprocate in the second direction DR2.

In this specification, it is illustrated that the stage ST may move along the third direction DR3, and the head unit HD moves along the second direction DR2. However, the disclosure is not limited thereto. In an embodiment, the inkjet printing device IPD may include a horizontal transfer unit (not shown) which moves the head unit HD in the third direction DR3, for example. In this case, rails RL1 and RL2 which move the stage ST in the third direction DR3 may be omitted. A means for changing a relative position of the stage ST and the head unit HD is not limited thereto.

In this specification, a planar surface of the head unit HD is illustrated to have a quadrangular shape, e.g., rectangular shape. However, the disclosure is not limited thereto.

The head unit HD may eject ink IK in a stopped state or in a moving state. In an embodiment, while the substrate SB is moving, the head unit HD may be stopped and eject ink IK. In another embodiment, while the substrate is stopped, the head unit HD may be moving and eject ink IK, for example. However, a means for the head unit's HD ejecting ink IK is not limited thereto.

In the disclosure, an amount of the head unit HD is illustrated to be one. However, the disclosure is not limited thereto. In an embodiment, a plurality of head units HD may be disposed on a lower surface of the inkjet printing head IPH. The plurality of head units HD may be aligned in one direction, for example. In another embodiment, the plurality of head units HD may be arranged in N rows (N is a natural number) and in a staggered manner. However, the disclosure is not limited thereto, and an arrangement structure of disposition of the plurality of head units HD may be limitlessly modified.

Although it is not separately illustrated in this specification, the head unit HD may include an ink storage unit (not shown) and an ink supply unit (not shown). The head unit HD may eject ink supplied from the ink storage unit at a selectable speed and amount through the ink supply unit. The ink supply unit (not shown) may include a piezoelectric device unit (not shown) and a pressure chamber (not shown).

The piezoelectric device unit (not shown) may include a piezo substrate, a first electrode (not shown), and a second electrode (not shown).

The piezo substrate may be a piezoelectric substrate and include a piezoelectric material modified according to driving voltages applied to the first electrode and the second electrode, respectively. The piezo substrate may shrink or expand according to a difference between the driving voltages applied to the first electrode and the second electrode, respectively, to generate a waveform. Ink IK may be moved to the nozzle unit NZZ by a pressure of the waveform.

The ink supply unit (not shown) may include an ink chamber (not shown) and a pressure chamber (not shown). The ink chamber may be a passageway for introducing ink. The pressure chamber, where ink IK to be ejected is filled, may be disposed on one side of the ink chamber.

The nozzle unit NZZ may be disposed adjacent to the head unit HD. Particularly, the nozzle unit NZZ may be disposed on a lower surface of the head unit HD. In FIG. 1 and FIG. 2, an amount of the nozzle unit NZZ is illustrated to be two. In addition, the nozzle unit NZZ is illustrated to be disposed side by side. However, the disclosure is not limited thereto, and an amount and arrangement of the nozzle unit NZZ may be limitlessly modified. Hereinafter, a detailed description about the nozzle unit NZZ will be made with reference to FIG. 3.

An inkjet printing device IPD in an embodiment of the disclosure may spray a selectable amount of ink IK on the substrate SB. Particularly, the ink IK may be sprayed to the substrate SB through the nozzle unit NZZ connected to one side of the head unit HD. Ink IK sprayed from the head unit HD may be in a solution form or in a colloid form. In an embodiment, ink IK may be acetone, water (H₂O), alcohol, toluene, propylene glycol, or propylene glycol methyl acetate, for example. However, the disclosure is not limited thereto.

Although it is not illustrated herein, an inkjet printing device IPD may further include a control unit (not shown).

The control unit may be connected to each element of the inkjet printing device IPD and control an overall operation of the inkjet printing device IPD. In an embodiment, the control unit may be electrically connected to the head unit HD, for example. The control unit may control the head unit HD to eject ink. The control unit may be electrically connected to a sensor (not shown) and receive a signal from the sensor.

FIG. 3 is a magnified illustration of an embodiment of a nozzle unit NZZ of an inkjet printing device IPD according to the disclosure. The nozzle unit NZZ may include a base layer BL, a supplementary part RP, a metal oxide layer MOL, a first metallic film MF1, a second metallic film MF2, and a monomolecular film SAF.

The base layer BL may have an opening area OP defined therein.

In this specification, passageways PH1 and PH2 for transfer of ink IK may be defined in a nozzle unit NZZ. The passageways PH1 and PH2 may include a first passageway PH1 and a second passageway PH2. The first passageway PH1 may have a shape whose cross-sectional area becomes narrower towards the second passageway PH2. However, disclosure is not limited thereto, and widths of the passageways PH1 and PH2 may be limitlessly modified. The second passageway PH2 may be extended to the first passageway PH1 and eject ink IK.

Although it is not illustrated in this specification, the nozzle unit NZZ may be provided in a plurality, and the plurality of nozzle units NZZ may be disposed in a zig-zag form. In addition, each of opening areas OP of the plurality of nozzle units NZZ may have a structure of an intersecting arrangement of a plurality of rows. This may show that the opening areas OP of the nozzle unit NZZ may overlap with each other in a cross-section.

The base layer BL may include a first portion AR1 and a second portion AR2.

The first portion AR1 may refer to a portion of the base layer BL disposed adjacent to the opening area OP.

The second portion AR2 may refer to a portion of the base layer BL extending from the first portion AR1.

The base layer BL may consist of a substrate of a material with good processibility. In an embodiment, the base layer BL may include a metallic material, such as stainless (Sus), iron (Fe), chromium (Cr), or nickel (Ni). In another embodiment, the base layer BL may consist of an organic material, such as polyimide (“PI”), for example. However, the disclosure is not limited thereto.

A thickness of the base layer BL may be about 60 micrometers (μm) to about 100 μm. In an embodiment, the base layer BL may have a thickness of about 75 μm, for example, but the disclosure is not limited thereto.

The base layer BL may have a shape of filling one side of the nozzle unit NZZ.

The supplementary part RP may be disposed below the base layer BL and overlap with the first portion AR1. In addition, the supplementary part RP may not overlap with the second portion AR2. A material of the supplementary part RP may include an organic material. In an embodiment, the supplementary part RP may include a monomer MN, for example. Particularly, the monomer MN may include methacrylate, acrylate, or epoxy. In addition, the monomer MN may include a material polymerized with a monomer MN composition including diacrylate-based monomer MN and a triacryalte-based monomer MN. However, the disclosure is not limited thereto.

The metal oxide layer MOL may be disposed below the base layer BL and overlap with the second portion AR2. In addition, the metal oxide layer MOL may not overlap with the first portion AR1.

The metal oxide layer MOL may be silicon oxide (SiOx), silicon nitride (SiNx), silicon oxynitride (SiOxNy), aluminum oxide (Al₂O₃), or aluminum nitride (AlN). Particularly, the metal oxide layer MOL may include a SiOc thin film having a shape of silicon oxide (SiOx) partially including carbon (C). A thickness of the metal oxide layer MOL may about 10 nanometers (nm) to about 20 nm. In an embodiment, a thickness of the metal oxide layer MOL may be about 15 nm, but the disclosure is not limited thereto.

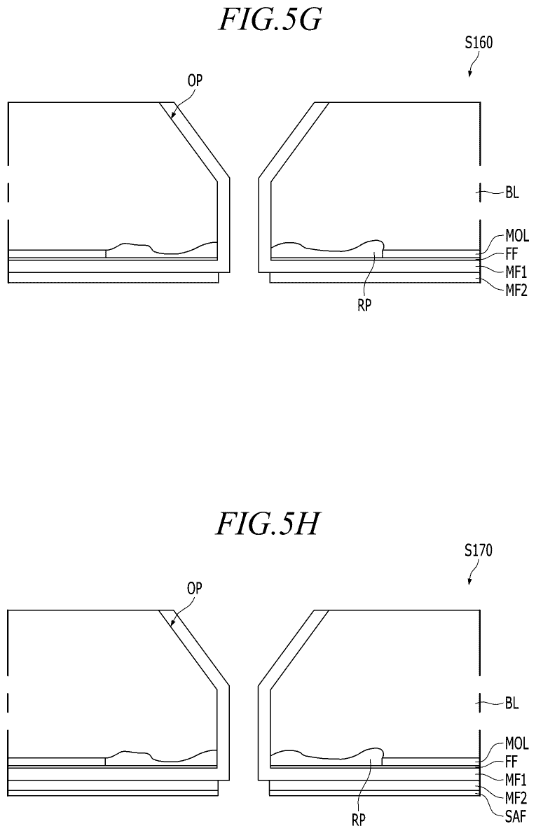

Detailed descriptions about why the supplementary part RP and the metal oxide layer MOL are disposed below the base layer BL will be made with reference to FIG. 5A through FIG. 5H.

In addition, before descriptions about the first metallic film MF1, the second metallic film MF2, and the monomolecular film SAF, descriptions about liquid repellency will be made. The first metallic film MF1, the second metallic film MF2, and the monomolecular film SAF relate to liquid repellency treatment of a surface of passageways PH1 and PH2. In the inkjet printing head IPH, surface treatment of the passageways PH1 and PH2 has direct effects on straightness and of an ink droplet ejected through the passageways and ink ejection performance, such as ejection speed. In order to enhance ink ejection performance, an inner wall of the passageways PH1 and PH2 are desired to have ink-philic property, and a surface closet to the second passageway PH2 is desired to have ink-phobic property. Particularly, in case that an inner wall of the passageways PH1 and PH2 has ink-philic property, a contact angle with ink becomes small, and a capillary force increases. Therefore, a time for refilling ink becomes reduced, and therefore, an ejection frequency may be increased.

Wettability may refer to a degree that liquid spreads on a solid surface. The wettability may be determined by a surface tension of the liquid and energy of the solid surface. The wettability may be usually measured by a contact angle. Here, the contact angle may refer to an angle between a liquid surface and a solid surface at a boundary formed when a liquid droplet is placed on a solid surface. The smaller the contact angle is (e.g., between 0 degrees and 90 degrees), the better liquid spreads on a surface. In this case, the liquid may be hydrophilic. An oxidized metallic surface may have a relatively small contact angle. The greater the contact angle is (e.g., between 90 degrees and 180 degrees), the less the liquid spreads on a surface. In case that the contact angle is large, liquid may form a spherical shape on a surface. In this case, the liquid may be hydrophobic. Other factors affecting the wettability may be a surface energy, a surface roughness, or surface coating, for example.

In case that a surface energy is large, liquid may be hydrophilic, and in case that a surface energy is small, liquid may be hydrophobic.

In case that a surface roughness is large, liquid may be hydrophilic, and in case that a surface roughness is small, liquid may be hydrophobic.

Such a wettability may be adjusted by performing methods, such as chemical coating or nano patterning, on a surface of the passageways PH1 and PH2.

In summary, an inner wall of the passageways are desired to be hydrophilic, and a surface closet to the second passageway PH2 is desired to be hydrophilic. Accordingly, when ink IK passes through the inner wall of the passageways PH1 and PH2, the ink IK may move straight. In addition, the surface closet to the second passageway PH2 is desired to have wettability for projecting ink to eventually eject the ink IK on a substrate SB.

In an embodiment of the disclosure, the first metallic film MF1 may have at least a portion overlapping with the supplementary part RP and a lower portion of the metal oxide layer MOL. The first metallic film MF1 may include or consist of a material having an excellent wear resistance property and have a function of protecting the supplementary part RP and the metal oxide layer MOL. The first metallic film MF1 may include aluminum oxide. Particularly, the first metallic film MF1 may include aluminum oxide having a chemical formula in a form of AlxOy (x and y are natural numbers). In an embodiment, the first metallic film MF1 may include, for example. However, the disclosure is not limited thereto.

The first metallic film MF1 may be formed through various coating or deposition methods. Particularly, the first metallic film MF1 may be formed through spin coating, sputtering, electron beam deposition, physical vapor deposition (“PVD”), chemical vapor deposition (“CVD”), dual-type thermal evaporation, metal organic CVD (“MOCVD”), plasma laser deposition (“PLD”), or atomic layer deposition (“ALD”), for example. In an embodiment, the first metallic film MF1 may be formed through ALD, for example. However, the disclosure is not limited thereto.

In addition, referring to FIG. 3, another portion of the first metallic film MF1 may be disposed in the opening area OP. In other words, the first metallic film MF1 may have a shape surrounding an inner side of the base layer BL. As described above, as ink IK is desired to be ejected along the inner wall of passageways PH1 and PH2, the first metallic film MF1 is desired to have a property to facilitate easy movement of ink IK. Accordingly, a material of the first metallic film MF1 may include or consist of a hydrophilic material.

A thickness of the first metallic film MF1 may be between about 1 nm and about 100 nm. In an embodiment, a thickness of the first metallic film MF1 may be about 50 nm, for example, but the disclosure is not limited thereto.

In an embodiment of the disclosure, a spacing between a lower surface of the first portion AR1 and the first metallic film MF1 may be a first distance D1. A spacing between a lower surface of the second portion AR2 and the first metallic film MF1 may be a second distance D2. The first distance D1 may be greater than the second distance D2.

In an embodiment of the disclosure, the supplementary part RP may have a first thickness, and the metal oxide layer MOL may have a second thickness. The first thickness may be greater than the second thickness.

In an embodiment of the disclosure, the supplementary part RP may have a first surface roughness, and the metal oxide layer MOL may have a second surface roughness. The first surface roughness may be greater than the second surface roughness.

In an embodiment of the disclosure, a second metallic film MF2 may be disposed below the first metallic film MF1. The second metallic film MF2 may include silicon oxide having a chemical formula of SiOx (x is a natural number).

In an embodiment, the second metallic film MF2 may include, for example, but the disclosure is not limited thereto. A thickness of the second metallic film MF2 may be between about 1 nm and about 50 nm. In an embodiment, a thickness of the second metallic film MF2 may be about 20 nm, for example, but the disclosure is not limited thereto. Here, the second metallic film MF2 may overlap with a portion of the first metallic film MF1. In addition, the second metallic film MF2 may be an adhesion layer to facilitate disposition of a thin film to be disposed on the second metallic film MF2.

The second metallic film MF2 may be formed through various coating or deposition methods. Particularly, the second metallic film MF2 may be formed through, e.g., spin coating, sputtering, electron beam deposition, PVD, CVD, dual-type thermal evaporation, MOCVD, PLD, or ALD. In an embodiment, the second metallic film MF2 may be formed through thermal-evaporation or electron beam (E-beam) evaporation, for example, but the disclosure is not limited thereto.

In an embodiment of the disclosure, a monomolecular film SAF may be disposed below the second metallic film MF2. The monomolecular film SAF may be formed by depositing a self-assembly monolayer (“SAM”). The monomolecular film SAF may have a function as a liquid repellent coating. Here, liquid repellency may refer to prevention of wetting due to not only water but also all sorts of liquid, including ink.

When a surface closet to the second passageway PH2 is hydrophilic, repeated ejection of ink IK may result in wetting of a portion, where ink IK is ejected, and formation of an ink lump. In this case, from the portion where ink IK is ejected, ink IK may be ejected in a manner that the ink IK flows down without forming a complete liquid droplet. As a result, an ejection direction of the ink IK may be distorted, ejection speed may be reduced, and printing quality may be reduced.

Accordingly, a monomolecular film SAF may be coated with a material having a property (wettability) for projecting ink IK. The monomolecular film SAF may prevent wetting by ink IK and facilitate ejection of the ink IK through the second passageway PH2.

The monomolecular film SAF may include or consist of an organic compound. In an embodiment, the monomolecular film SAF may have a silanol group at a molecular end, for example. In addition, the monomolecular film SAF may have multiple molecular chains having a hydrophilic group. In another embodiment, the monomolecular film SAF may be formed with a silane group SAM, a thiol group SAM, a silicon-based compound, or a fluorine-based compound. In an embodiment, the monomolecular film SAF may include or consist of polytetra Teflon® ethyleneglycol (“PTFE”), a Teflon-based material, for example.

A thickness of the monomolecular film SAF may be about 5 to about 20 nm, for example. However, the disclosure is not limited thereto.

The monomolecular film SAF may be formed through various coating or deposition methods. Particularly, the monomolecular film SAF may be formed through spin coating, sputtering, electron beam deposition, PVD, CVD, dual-type thermal evaporation, MOCVD, PLD, or ALD, for example. In an embodiment, the monomolecular film SAF may be formed through ALD, for example, but the disclosure is not limited thereto.

Hereinafter, a method for forming a thin film is simply described. There are two main methods for forming a thin film. These are CVD that forms an insulating film or a metallic film through a chemical method, and a PVD that forms an insulating film or a metallic film through a physical method. The CVD and the PVD are methods of having several molecules reacted on a surface and simultaneously depositing a film. Accordingly, the CVD and the PVD have difficulty in controlling a thickness of a thin film and obtaining uniformity of a thin film.

However, ALD is a method of depositing a substantially thin, uniform thin film with an atomic level thickness.

The ALD is a process of depositing a thin film on a surface of a substrate by utilizing a self-limiting reaction of a precursor through processes of chemical adsorption, surface reaction, and by-product desorption. Here, the self-limiting reaction may refer that only a reaction between a reactant and a substrate occurs, and no reaction between reactants occurs.

Particularly, in the ALD, introduction of a first source (precursor) to a process chamber (not shown) leads to an adsorption on a surface. Subsequently, introduction of a second source (reactant) of a different type leads to chemical substitution with the first adsorbed material and eventual formation of a new thin film. After respective introduction of the first source (precursor) and the second source (reactant) in the ALD, purging for removing the precursor or reaction by-product may be performed. The purging may be introduction of chemically stable argon (“AR”) or nitrogen (N2) gas. As the ALD is desired to be repeated several times to deposit several atomic layers through a same chemical reaction, a surface of a thin film after one cycle is desired to have a same chemical property as an existing substrate.

The precursor is desired to be thermally stable as thermal decomposition is desired to be prevented. In addition, the precursor is desired to produce a strong exothermic reaction with a chemical composition of a substrate surface to be rapidly adsorbed. In addition, the precursor is desired not to cause etching of a substrate or an existing thin film or damage to a thin film.

The precursor may be distinguished based on a thin film to be deposited. A material, such as H₂O, O₂, or H₂O₂, may be used for formation of an oxide film. A material, such as NH₃ or N₂H₄, may be used for formation of a nitride film. In addition, material, such as a halide, an amide, an alkyl, an amino composition, or a carbonyl, may be used for formation of a metallic thin film.

As an adsorption method is applied for ALD, there may be little step coverage. In addition, in the ALD, there may be few pinch holes with extremely relatively small diameters on a surface.

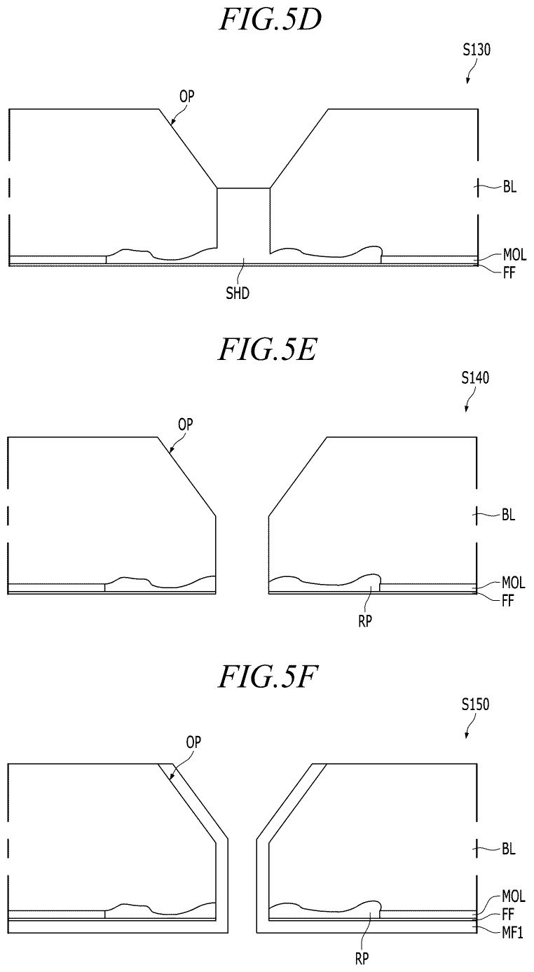

FIG. 4 is a flow chart of an embodiment of a manufacturing method S10 for an inkjet printing head according to the disclosure.

In an embodiment of the disclosure, a manufacturing method S10 for an inkjet printing head may include an operation S100 of preparing, an operation S110 of forming a shield unit, operation S120 of etching the shield unit, an operation S130 of forming a planarization film, operation S140 of forming a passageway, an operation S150 of forming a first metallic film, an operation S160 of forming a second metallic film, and an operation S110 of forming a monomolecular film S170.

FIG. 5A through FIG. 5H are subsequential illustrations of an embodiment of a manufacturing method S10 for an inkjet printing head according to the disclosure.

The disclosure relates to a manufacturing method S10 for an inkjet printing head for re-use after using an inkjet printing device IPD. Normally, upon repeated uses of an inkjet printing device IPD, undischarged ink may be stuck in passageways PH1 and PH2. Specifically, ink IK formed on a surface closet to the second passageway PH2 may deteriorate ejection performance of ink IK to be ejected after or block the passageways PH1 and PH2. Accordingly, a blotting process may be proceeded to periodically clean the inkjet printing head IPH. Normally, a blotting process is a process of cleaning the inkjet printing head IPH with tools, such as a cloth or a patch. Upon wiping an entirety of the surface of the inkjet printing head IPH, the inkjet printing head IPH may be worn out due to friction. Particularly, a metal coated layer of a surface closet to the second passageway PH2 may be peeled off. Accordingly, a shape having a portion of the metal oxide layer MOL and a portion of a base layer BL removed may be shown as in FIG. 5A. The removed portion of the metal oxide layer MOL may have an uneven shape. There is a problem in re-using the inkjet printing head IPH after successively coating a first metallic film MF1, a second metallic film MF2, and a monomolecular film SAF from the above state. As the removed portion of the metal oxide layer MOL has an uneven shape, successive coating of a first metallic film MF1, a second metallic film MF2, and a monomolecular film SAF on the uneven shape results in a generally uneven shape of a surface closet to the second passageway PH2. Ejection of ink IK in this state significantly reduces ejection performance, and ink IK cannot be deposited at a correct location. Therefore, the disclosure includes a process of filling a surface closet to the second passageway PH2.

Referring to FIG. 4 and FIG. 5A, in the operation S100 of preparing, a damaged inkjet printing head IPH may be prepared. The damaged inkjet printing head IPH may include a head unit HD and a nozzle unit NZZ disposedadjacent to the head unit HD. As described above, in the operation of preparing S100, the nozzle unit NZZ may include a base layer BL and a metal oxide layer MOL disposed below a portion of the base layer BL.

Referring to FIG. 4 and FIG. 5B, the operation S110 of forming a shield unit may be performed after the operation of preparing S100. In the operation S110 of preparing a shield unit, a material composed of an organic material may be applied to an opening area OP and another portion of the base layer BL. In an embodiment, the applied material may include a monomer MN. However, the disclosure is not limited thereto. Hereinafter, the applied material may be referred as a monomer MN for convenience.

The monomer MN may be in a liquid state and applied in a direction from the second passageway PH2 towards the first passageway PH1. In case that monomer MN is applied and pre-cured, a portion of the second passageway PH2 and the surface closet to the second passageway PH2 may be shielded. As described above, the shield portion may be referred as a shield unit SHD.

In the process that the liquid monomer MN is applied and pre-cured, a surface of a portion adjacent to the second passageway PH2 may be cured to a non-flat state.

In this specification, it is illustrated that the monomer MN entirely fills the second passageway PH2, but the disclosure is not limited thereto. It is sufficient as long as the monomer MN plays a role in planarizing the uneven surface in a region adjacent to the second passageway PH2.

In application of the monomer MN, a spray coater which sprays a liquid material through a spray may be utilized. In another embodiment, a spin coating method, in which a material to be applied is rotated to have a polymer thinly spread over an entirety of the surface for coating, may be utilized.

Referring to FIG. 4 and FIG. 5C, after the operation S110 of forming a shield unit, an operation S120 of the etching the shield unit may be performed. In the operation S120 of etching the shield unit, a portion of the shield unit SHD may be etched. Particularly, the shield unit SHD not overlapping with a lower side of the metal oxide layer MOL in a plan view may be etched and removed. By performing the operation S120 of etching the shield unit, lower surfaces of the metal oxide layer MOL and the shield unit SHD may become flat.

Here, the etching may be performed through a conventional method. In an embodiment, the etching process may be dry etching, wet etching, reactive ion etching (“RIE”), or inductively coupled plasma RIE (“ICP-RIE”), for example. However, the disclosure is not limited thereto.

Referring to FIG. 4 and FIG. 5D, after the operation S120 of etching the shield unit, an operation S130 of the forming a planarization film may be performed. In the operation S130 of forming a planarization film, a planarization film FF may be disposed below the metal oxide layer MOL and the shield unit SHD. The planarization film FF may protect and planarize the metal oxide layer MOL and the shield unit SHD, respectively.

The planarization film FF may include an organic material, such as a general-purpose polymer, a polymer derivative having a phenol-based group, an acryl-based polymer, an imide-based polymer, an aryl ether-based polymer, an amide-based polymer, a fluorine-based polymer, or a p-xylene-based polymer. However, the disclosure is not limited thereto.

A thickness of the planarization film FF may be between about 1 nm and about 10 nm. In an embodiment, the thickness of the planarization film FF may be about 5 nm, for example, but the disclosure is not limited thereto. The thickness of the planarization film FF may be minimized to prevent the thin film to be laminated after from becoming thick. Hereinafter, a description substantially same as the descriptions for FIG. 3 will be omitted.

Referring to FIG. 4 and FIG. 5E, after the operation of forming a planarization film S130, an operation S140 of the forming a passageway may be performed. The operation S140 of forming a passageway may be performed in a direction perpendicular to a surface of the second passageway PH2. In the operation S140 of forming a passageway, a portion of the shield unit SHD and the planarization film FF exposed by the opening area OP may be removed by utilizing reactive ion etching or an asher. In another embodiment, in the operation S140 of forming a passageway, a portion of the shield unit SHD and the planarization film FF exposed by the opening area OP may be removed by utilizing a cleaning solution of an acetone type.

In the disclosure, the unremoved shield unit SHD in the operation of forming a passageway S140 may be referred as a supplementary part RP. The supplementary part RP may fill a region without a metal oxide layer MOL below the base layer BL.

Here, the cleaning solution of an acetone type may be a material usually utilized for washing an electronic part or a precision machine. The cleaning solution of an acetone type may precisely and thoroughly remove a foreign substance from a surface. The cleaning solution of an acetone type may be suitable for washing various surfaces, such as plastic, metal, or glass. In another embodiment, in the operation S140 of forming a passageway, passageways PH1 and PH2 may be formed through an air purge process.

In an embodiment of the disclosure, the operation S140 of forming a passageway may further include providing an etchant solution (not shown). An acetone-type etchant solution or a potassium hydroxide (“KOH”) etchant solution may be utilized as the etchant solution. However, the disclosure is not limited thereto.

The operation S140 of forming a passageway may include introducing a cleaning solution of an acetone-type to an ink introduction unit (not shown) of the head unit HD. Here, the shield unit SHD exposed by the opening area OP and the planarization film FF overlapping with the opening area OP in a plan view may be simultaneously removed. However, the disclosure is not limited thereto.

In an embodiment, the shield unit SHD exposed by the opening area OP may be primarily removed, for example. Thereafter, the planarization film FF overlapping with the opening area OP in a plan view may be secondarily removed. Accordingly, passageways PH1 and PH2 for ejection of ink IK are formed. In addition, preferably, a surface of the second passageway PH2 may be perpendicular to the planarization film FF.

Referring to FIG. 4 and FIG. 5F, after the operation S140 of forming a passageway, operation S150 of the forming a first metallic film may be performed. The operation S150 of forming a first metallic film may include forming a first metallic film MF1 disposed below the metal oxide layer MOL. Descriptions about a material and disposition of the first metallic film MF1 are substantially same as the above descriptions for FIG. 3, and therefore omitted.

Referring to FIG. 4 and FIG. 5G, after the operation S150 of forming a first metallic film, an operation S160 of the forming a second metallic film may be performed. The operation S160 of forming a second metallic film may include forming a second metallic film MF2 disposed below the first metallic film MF1. Descriptions about a material and disposition of the second metallic film MF2 are substantially same as the above descriptions for FIG. 3, and therefore omitted.

Referring to FIG. 4 and FIG. 5H, after the operation S160 of forming a second metallic film, an operation S170 of the forming a monomolecular film may be performed. The operation of forming a monomolecular film S170 may include forming a monomolecular film SAF disposed below the second metallic film MF2. Descriptions about a material and disposition of the monomolecular film SAF are substantially same as the above descriptions for FIG. 3, and therefore omitted.

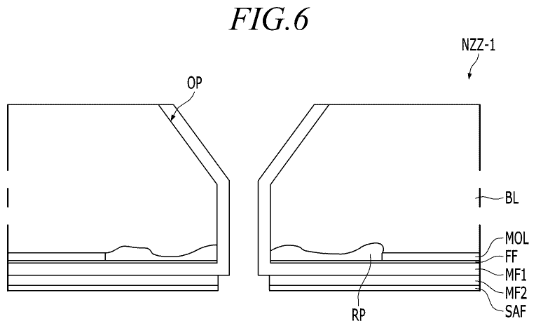

FIG. 6 is a magnified illustration of an embodiment of a nozzle unit NZZ-1 of an inkjet printing device IPD according to the disclosure.

The nozzle unit NZZ-1 may include a base layer BL, a supplementary part RP, a metal oxide layer MOL, a planarization film FF, a first metallic film MF1, a second metallic film MF2, and a monomolecular film SAF.

FIG. 6 is different from FIG. 3 in that a planarization film FF is disposed between the metal oxide layer MOL and the first metallic film MF1. The planarization film FF may cover the metal oxide layer MOL and the supplementary part RP, respectively. In addition, the planarization film FF may be configured for planarization to facilitate disposition of a thin film to be disposed on the planarization film FF. Descriptions about a material and a thickness of the planarization film FF are substantially same as the above descriptions for FIG. 5D, and therefore omitted.

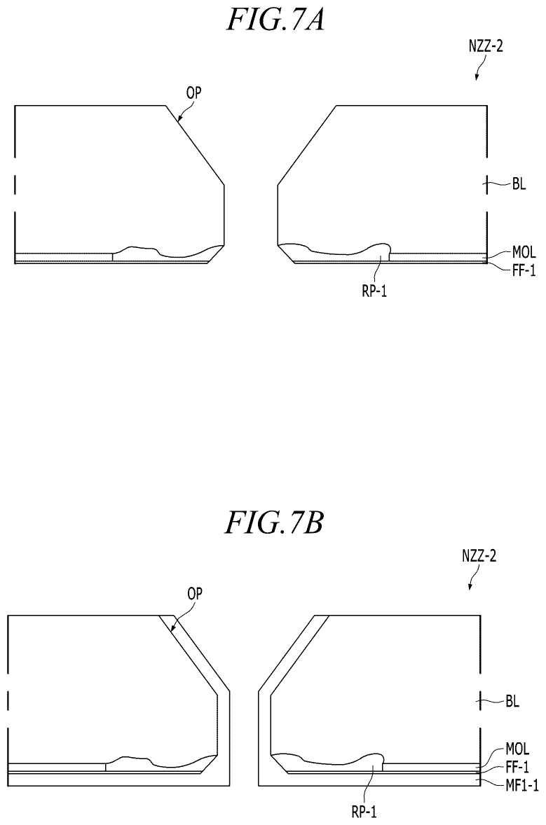

FIG. 7A and FIG. 7B are magnified illustrations of another embodiment of a nozzle unit NZZ-2 of an inkjet printing device IPD according to the disclosure. FIG. 7A is different from FIG. 5E in a shape of the remaining supplementary part RP-1 among the shield unit after the operation of forming a passageway S140. Accordingly, a shape of a planarization film FF-1 laminated on the metal oxide layer MOL and the supplementary part RP-1 is also different from that of FIG. 5E.

In the operation of forming a passageway S140, when the shield unit SHD exposed by the opening area OP is removed, a portion of the supplementary part RP-1 closet to a surface of the second passageway PH2 may be partially removed. Subsequently, referring to FIG. 7B, it is shown that the first metallic film MF1-1 also covers a portion where the supplementary part RP-1 is removed. As described for FIG. 3, the first metallic film MF1-1 may be deposited through ALD. As the ALD is a method of deposition to an atomic unit, it would be easy for the supplementary part RP-1 to cover the removed portion. Although it is not separately illustrated in this specification, the second metallic film MF2 and the monomolecular film SAF may be subsequently disposed below the first metallic film MF1-1. Descriptions about a material and a disposition structure of the second metallic film MF2 and the monomolecular film SAF are substantially same as the descriptions for FIG. 3, and therefore omitted.

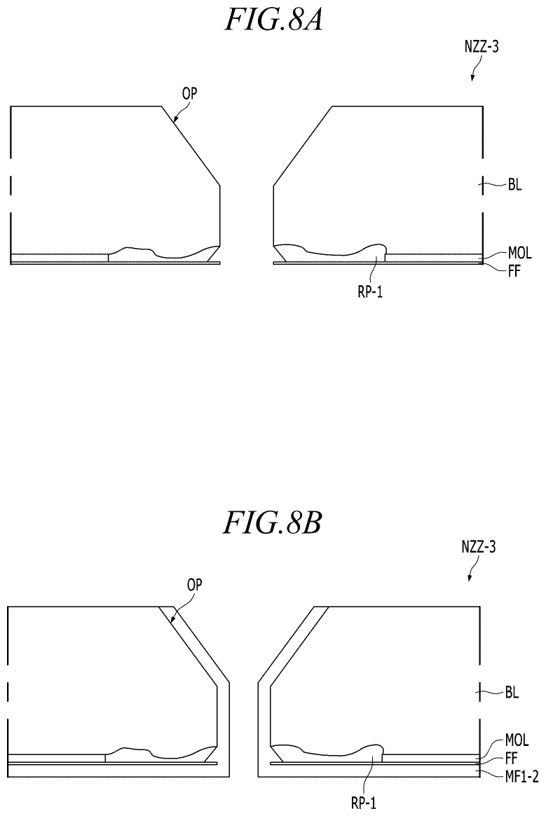

FIG. 8A and FIG. 8B are magnified illustrations of an embodiment of a nozzle unit NZZ-3 of an inkjet printing device IPD according to the disclosure.

FIG. 8A is different from FIG. 7A in a shape of the etched planarization film FF in the operation of forming a passageway S140. As described for FIG. 5E, in the operation of forming a passageway S140, the shield unit SHD exposed by the opening area OP may be primarily removed. As in FIG. 7A, a portion of the supplementary part RP-1 closet to a surface of the second passageway PH2 may be partially removed. However, in the planarization film FF, only a portion exposed by the opening area OP may be removed. Accordingly, the planarization film FF may have a shape in which some of the planarization film FF protrude than the supplementary part RP-1.

Subsequently, referring to FIG. 8B, the first metallic film MF1-2 may cover a region between the planarization film FF and the removed portion of supplementary part RP-1. As described for FIG. 3, the first metallic film MF1-2 may be deposited through ALD. As the ALD is a method of deposition to an atomic unit, the removed portion of the supplementary part RP-1 may be easily covered. Although it is not separately illustrated in this specification, a second metallic film MF2 and a monomolecular film SAF may be disposed below the first metallic film MF1-2. Descriptions about a material and disposition of the second metallic film MF2 and the monomolecular film SAF are substantially same as the descriptions for FIG. 3, and therefore omitted.

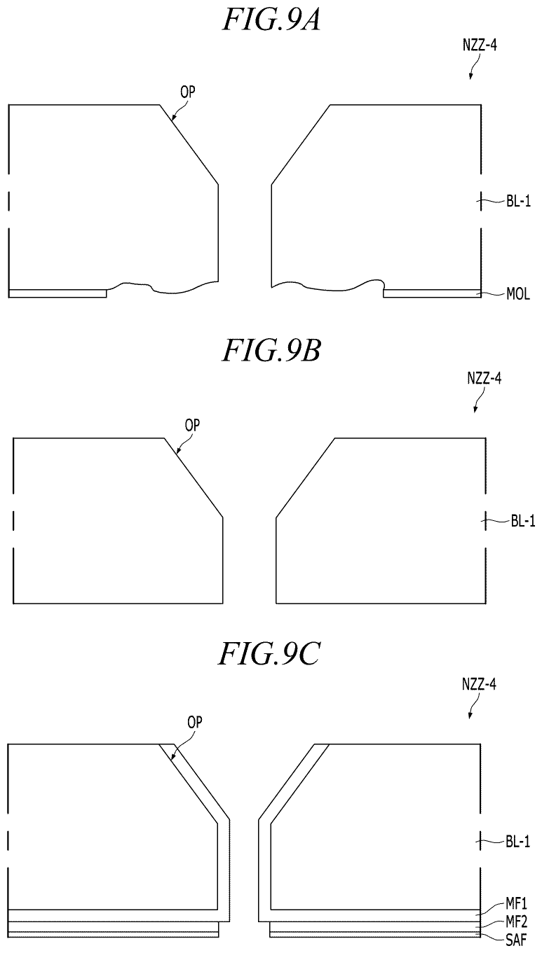

FIG. 9A through FIG. 9C are magnified illustrations of an embodiment of a nozzle unit NZZ-4 of an inkjet printing device IPD according to the disclosure.

FIG. 9A is an illustration of a damaged inkjet printing device IPD. Upon implementing a blotting process on an inkjet printing device IPD after its use, only a portion of the metal oxide layer MOL remains on an inner surface of the base layer BL-1. The removed portion of the metal oxide layer MOL on the inner surface of the base layer BL-1 may have an uneven surface due to friction applied during the blotting process. Instead of filling the uneven surface with another material (e.g., a monomer), an etching process on the uneven surface may be performed. In consideration of the portion to be etched, the base layer BL-1 of the nozzle unit NZZ-4 may be designed to be thicker than a conventional one. In an embodiment, the base layer BL-1 may have a thickness of about 90 μm, for example, but the disclosure is not limited thereto.

FIG. 9B is an illustration in which a portion of an uneven surface in FIG. 9A is etched. Accordingly, a portion adjacent to a surface of the second passageway PH2 may be planarized. In case that the base layer BL-1 is designed to be thicker than a conventional one and an uneven surface is etched, a thickness of the base layer BL-1 may be about 75 μm. However, the disclosure is not limited thereto.

FIG. 9C illustrates that a first metallic film MF1, a second metallic film MF2, and a monomolecular film SAF are successively laminated in FIG. 9B. As the portion adjacent to the second passageway PH2 is planarized, ink IK ejected through the second passageway PH2 may be ejected on a substrate SB with an excellent liquid ejection property. Hereinafter, descriptions about a material and function of the first metallic film MF1, the second metallic film MF2 and the monomolecular film SAF are substantially same as the descriptions for FIG. 3, and therefore omitted.

While illustrative embodiments of the disclosure have been described above, anyone ordinarily skilled in the art to which the disclosure pertains shall appreciate that there may be a variety of modifications and permutations of the disclosure without departing from the technical ideas and scopes of the disclosure that are defined in the appended claims. Moreover, it shall be appreciated that the disclosed embodiments are not intended to restrict the disclosure thereto and that every technical idea within the appended claims and their equivalents is interpreted to be included in the scope of the disclosure.

What is claimed is:

1. An inkjet printing head comprising:
a head unit; and
a nozzle unit disposed adjacent to the head unit, the nozzle unit comprising:
a base layer having an opening area defined therein, and comprising a first portion adjacent to the opening area and a second portion extending from the first portion;
a supplementary part disposed below the base layer and overlapping with the first portion;
a metal oxide layer disposed below the base layer and overlapping with the second portion; and
a first metallic film having at least a portion disposed below the supplementary part and the metal oxide layer.

2. The inkjet printing head of claim 1,
wherein a first distance between a lower surface of the first portion and the first metallic film is different from a second distance between a lower surface of the second portion and the first metallic film.

3. The inkjet printing head of claim 2,
wherein the first distance is greater than the second distance.

4. The inkjet printing head of claim 1,
wherein a first thickness of the supplementary part is different from a second thickness of the metal oxide layer.

5. The inkjet printing head of claim 4,
wherein the first thickness is greater than the second thickness.

6. The inkjet printing head of claim 2,
wherein the supplementary part has a first surface roughness, and the metal oxide layer has a second surface roughness smaller than the first surface roughness.

7. The inkjet printing head of claim 1,
wherein another portion of the first metallic film is disposed in the opening area.

8. The inkjet printing head of claim 1, further comprising a second metallic film disposed below the first metallic film.

9. The inkjet printing head of claim 8, further comprising a monomolecular film disposed below the second metallic film.

10. The inkjet printing head of claim 1, further comprising a planarization film disposed between the metal oxide layer and the first metallic film.

11. The inkjet printing head of claim 1, wherein the metal oxide layer comprises silicon oxide.

12. An inkjet printing device comprising:
a stage for mounting a substrate;
a head unit disposed on the stage and configured to supply ink; and
a nozzle unit disposed adjacent to the head unit and forming a first passageway configured to eject the ink on the substrate and a second passageway extended to the first passageway defined therein, the nozzle unit comprising:
a base layer comprising a first portion adjacent to the second passageway and a second portion extending from the first portion;
a supplementary part disposed below the base layer and overlapping with the first portion;
a metal oxide layer disposed below the base layer and overlapping with the second portion; and
a first metallic film disposed below the supplementary part and the metal oxide layer.

13. The inkjet printing device of claim 12,
wherein the first passageway has a smaller width towards the second passageway, and
wherein at least a portion of the supplementary part overlaps with the first passageway in a plan view.

14. The inkjet printing device of claim 12,
wherein a spacing between a lower surface of the first portion and the first metallic film is a first distance,
wherein a spacing between a lower surface of the second portion and the first metallic film is a second distance, and
wherein the first distance is greater than the second distance.

15. The inkjet printing device of claim 12,
wherein the supplementary part has a first thickness, and the metal oxide layer has a second thickness different from the first thickness, and
wherein the first thickness is greater than the second thickness.

16. The inkjet printing device of claim 12,
wherein the supplementary part has a first surface roughness, and the metal oxide layer has a second surface roughness smaller than the first surface roughness.

17. A manufacturing method for an inkjet printing head, the manufacturing method comprising:
preparing a damaged inkjet printing head comprising a head unit and a nozzle unit disposed adjacent to the head unit, the nozzle unit comprising a base layer having an opening area defined therein and a metal oxide layer disposed below a portion of the base layer;
forming a shield unit by applying a material comprising a monomer to the opening area and another portion of the base layer and pre-curing the applied material;
etching the shield unit for etching some of the applied material;
forming a passageway for introducing a cleaning solution through the opening area and removing a portion of the shield unit disposed in the opening area;
forming a first metallic film below the metal oxide layer;
forming a second metallic film below the first metallic film; and
forming a monomolecular film below the second metallic film.

18. The manufacturing method for an inkjet printing head of claim 17, further comprising:
forming a planarization film below the metal oxide layer between the etching the shield unit and the forming the passageway.

19. The manufacturing method for an inkjet printing head of claim 17, wherein the cleaning solution comprises a material of an acetone type.

20. The manufacturing method for an inkjet printing head of claim 17, wherein the forming the first metallic film and the forming the second metallic film are each performed by any one of an atomic layer deposition method, a physical vapor deposition method, and a sputter deposition method.
